(19) United States
(12) Patent Application Publication
(10) Pub. No.: US 2023/0055176 A1
(43) Pub. Date: Feb. 23, 2023

(54) ELECTROLYSIS ARRANGEMENT AND METHOD WITH ANOLYTE COOLER

(71) Applicant: L'Air Liquide, Société Anonyme Pour I'Etude et I'Exploitation des Georges Claude, Paris (FR)

(72) Inventors: Jean-Philippe TADIELLO, Frankfurt am Main (DE); Markus Nesselberger, Frankfurt am Main (DE); Tibor Svitnic, Samorin (SK)

(21) Appl. No.: 17/888,127

(22) Filed: Aug. 15, 2022

(30) Foreign Application Priority Data
Aug. 17, 2021 (EP) 21020418.6

(51) Int. Cl. C25B 15/021; C25B 1/04

(52) U.S. Cl. CPC C25B 15/021; C25B 1/04

(57) ABSTRACT

The invention relates to an electrolysis arrangement and a method for producing hydrogen and oxygen by electrolysis of an aqueous electrolysis medium, in particular a corrosive electrolysis medium. According to the invention, the electrolyte cooler to maintain the desired operating temperature of the electrolysis cell stack is arranged downstream of the electrolysis cell stack and upstream of the anolyte gas-liquid separator. By this arrangement, less corrosion resistant materials can be used in particular on the anode side of the electrolysis arrangement, since conduits and further components on the anode side of the electrolysis arrangement are exposed to lower temperatures.

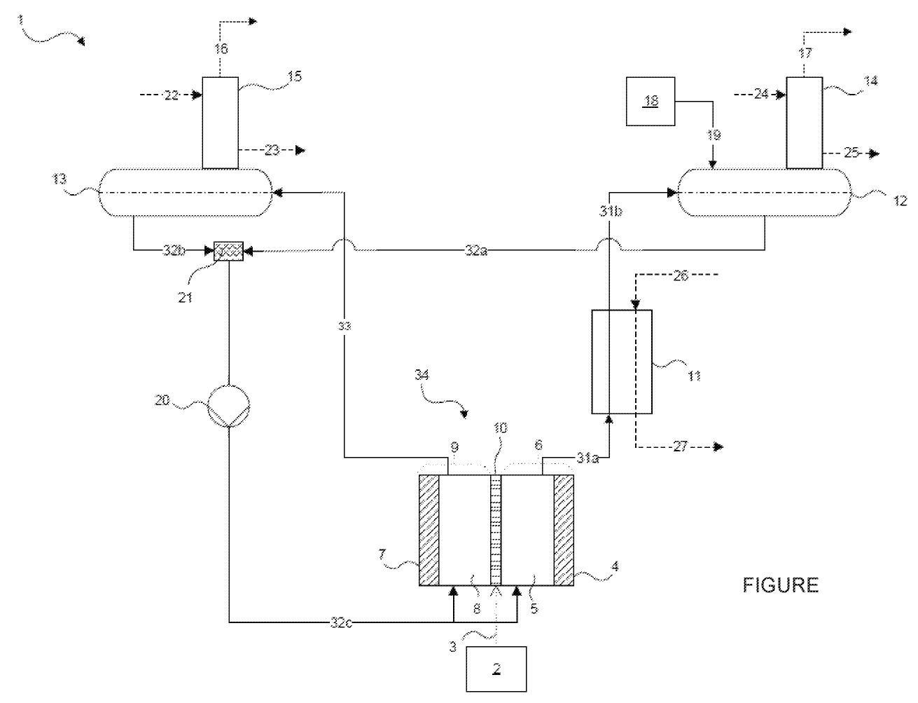

### CROSS REFERENCE TO RELATED APPLICATIONS

This application claims the benefit of priority under 35 U.S.C. § 119 (a) and (b) to European Patent Application No. 21020418.6, filed Aug. 17, 2021, the entire contents of which are incorporated herein by reference.

### TECHNICAL FIELD

The invention relates to an electrolysis arrangement for performing electrolysis in an industrial scale. The invention further relates to a method for producing hydrogen and oxygen by electrolysis in an industrial scale.

### BACKGROUND ART

In industrial electrolysis applications, electrolysis media are often used that are corrosive to the components of the electrolyser and the piping system. Metal components are particularly affected. Alkaline electrolysis is well established technology and uses a concentrated lye solution as the electrolyte. Since the conductivity of the electrolyte and the catalyst activity of the electrodes, and therefore the efficiency of the electrolyser, increase with the temperature, it becomes more usual to operate the alkaline water electrolyser at higher temperatures, as long as the electrolyser components are not subject to degradation. This leads to the requirement of corrosion resistant materials, in particular corrosion resistant metals and alloys.

The highest corrosion occurs on the anode side of the electrolyser, as high concentrations of oxygen increase the corrosion.

The heat exchanger removing the heat generated in the electrolysis cell stack of the electrolyser is usually installed downstream of the gas-liquid separators employed to separate the generated hydrogen and oxygen gas from the electrolysis medium. In such arrangements, most of the equipment is exposed to a high temperature electrolysis medium, in particular concentrated lye solution in alkaline electrolysis, consequently having high corrosion rates. This applies due to the exposure to oxygen in particular to the piping system between the electrolysis cell stack and the anode gas-liquid separator, as well as to the anode gas-liquid separator itself.

Hence, in particular for the equipment used at the anode side of the electrolysis arrangement, with temperature going up to 90° C., corrosion resistant materials such as pure Nickel needs to be used, which increases the capital expenditures of the electrolysis system. Furthermore, the release of Nickel ions into the electrolysis medium pollutes the electrolyser and may increase the rate of electrolysis cell stack performance degradation.

### SUMMARY

It is a general object of the present invention to provide an electrolysis arrangement which at least in part overcomes the problems of the prior art.

It is a further object of the present invention to provide an alkaline electrolysis arrangement system which at least in part overcomes the problems of the prior art.

It is a further object of the present invention to provide an electrolysis arrangement with components and piping which are subject to lower requirements in terms of corrosion resistance.

It is a further object of the present invention to provide an electrolysis arrangement, in particular an alkaline electrolysis arrangement, which requires fewer components and piping that are made of a pure Nickel material.

It is a further object of the present invention to provide an electrolysis arrangement which requires fewer components and piping on the anode side of the electrolysis arrangement that are highly resistant to corrosive media.

It is a further object of the present invention to provide an electrolysis arrangement, in particular an alkaline electrolysis arrangement, which requires fewer components and piping on the anode side of the electrolysis arrangement that are made of a pure Nickel material.

It is a further object of the present invention to provide a method which at least partially solves at least one of the aforementioned problems.

A contribution to the at least partial solution of at least one of the above mentioned objects is provided by the subject-matter of the independent claims. The dependent claims provide preferred embodiments which contribute to the at least partial solution of at least one of the objects. Preferred embodiments of elements of a category according to the invention shall, if applicable, also be preferred for components of same or corresponding elements of a respective other category according to the invention.

The terms “having”, “comprising” or “containing” etc. do not exclude the possibility that further elements, ingredients etc. may be comprised. The indefinite article “a” or “an” does not exclude that a plurality may be present.

In general, at least one of the underlying problems is at least partially solved by an electrolysis arrangement, comprising
an electrolysis cell stack comprising a plurality of electrolysis cells for the electrochemical generation of hydrogen and oxygen from an electrolysis medium, wherein the electrolysis cell stack comprises an anode section for the generation of oxygen and a cathode section for the generation of hydrogen;
an anolyte gas-liquid separator for the separation of oxygen gas from an oxygen loaded anolyte portion of the electrolysis medium;
a catholyte gas-liquid separator for the separation of hydrogen gas from a hydrogen loaded catholyte portion of the electrolysis medium;
an anolyte cooler, wherein said anolyte cooler is arranged downstream of the electrolysis cell stack and upstream of the anolyte gas-liquid separator, in order to cool the oxygen loaded anolyte portion of the electrolysis medium before it enters the anolyte gas-liquid separator.

According to the invention, the cooler for the electrolysis medium heated in the electrolysis cell stack is arranged on the anode side of the electrolysis arrangement and cools the oxygen loaded anolyte portion of the electrolysis medium, hence referred to as anolyte cooler. In particular, the cooler is arranged downstream of the electrolysis cell stack and upstream of the anolyte gas-liquid separator. That is, the anolyte cooler is arranged between the electrolysis cell stack and the anolyte gas-liquid separator.

In one embodiment, the electrolysis medium is a corrosive electrolysis medium. In particular, the electrolysis medium is a corrosive electrolysis medium which is corrosive to metals and/or metal alloys.

According to the invention, the fact is used that corrosion is reduced at lower temperatures. Corrosion is furthermore highest when equipment or a pipe is exposed to high temperatures, such as 90° C., and furthermore to oxygen. By arranging the electrolyte cooler between the electrolysis cell stack and the anolyte gas-liquid separator, the corrosion rate is reduced on the most susceptible pieces of equipment, that is piping downstream of the anode section of the electrolysis cell stack and the anolyte gas-liquid separator itself.

According to one embodiment, the anolyte cooler is arranged directly at or proximately to the outlet of the anode section of the electrolysis cell stack.

By arranging the anolyte cooler directly at or proximately to the outlet of the anode section of the electrolysis cell stack, only a small piece of piping between the electrolysis cell stack and the anolyte cooler or no piping at all is exposed to the high temperature anolyte withdrawn from the electrolysis cell stack. Hence, most of the piping between the electrolysis cell stack and the anolyte gas-liquid separator, which is the piping between the anolyte cooler and the anolyte gas-liquid separator, can be made of a material which is less resistant to corrosion because it is exposed to lower temperatures.

According to one embodiment, the electrolysis medium is an aqueous medium, in particular an aqueous alkaline medium, in particular an aqueous concentrated potassium hydroxide (KOH) solution with a KOH concentration of up to 30 wt.-%, or up to 35 wt.-%, or up to 40 wt.-%.

According to one embodiment, the anolyte cooler is arranged within a first piping system, wherein the first piping system connects an outlet of the anode section of the electrolysis cell stack and an inlet of the anolyte gas-liquid separator.

That is, the first piping system is configured to supply the oxygen loaded anolyte withdrawn from the anode section of the electrolysis cell stack to the inlet of the anolyte gas-liquid separator. The anolyte cooler is arranged within the first piping system. That is, the inlet of the anolyte cooler is connected to an outlet of the anode section of the electrolysis cell stack and the outlet of the anolyte cooler is connected to an inlet of the anolyte gas-liquid separator.

According to one embodiment, the electrolysis arrangement comprises a second piping system, wherein the second piping system connects an outlet of the anolyte gas-liquid separator and an outlet of the catholyte gas-liquid separator with an inlet of the electrolysis cell stack, in order to withdraw hydrogen depleted catholyte from the catholyte gas-liquid separator and to withdraw oxygen depleted anolyte from the anolyte gas-liquid separator, and to supply the hydrogen depleted catholyte and the oxygen depleted anolyte to the electrolysis cell stack.

The second piping system connects both the anode gas-liquid separator and the cathode gas-liquid separator with an inlet of the electrolysis cell stack. In the gas-liquid separators, hydrogen and oxygen gas are separated from the hydrogen and oxygen loaded electrolysis medium withdrawn from the electrolysis cell stack and supplied to the gas-liquid separators. The resulting hydrogen and oxygen depleted electrolysis medium is withdrawn from the gas-liquid separators and supplied via the second piping system to an inlet of the electrolysis cell stack. The oxygen depleted anolyte and the hydrogen depleted catholyte usually contain residual dissolved hydrogen and/or oxygen. The oxygen depleted anolyte and the hydrogen depleted catholyte are supplied to the electrolysis cell stack either separated, partially mixed or fully mixed.

Therefore, according to one embodiment, the second piping system comprises a mixing device arranged downstream of the anolyte gas-liquid separator and downstream of the catholyte gas-liquid separator, in order to at least partially mix the hydrogen depleted catholyte and the oxygen depleted anolyte to obtain a mixed hydrogen and oxygen depleted electrolyte, to supply the mixed hydrogen and oxygen depleted electrolyte to the inlet of the electrolysis cell stack.

Before entering the electrolysis cell stack, the oxygen and hydrogen depleted electrolyte may be split, wherein a portion enters the electrolysis cell stack via an inlet at the anode section and a portion enters the electrolysis cell stack via an inlet at the cathode section.

According to one embodiment, no cooling device is arranged within the second piping system.

It was surprisingly found that cooling of the oxygen loaded anolyte by means of the anolyte cooler alone is sufficient to keep the temperatures of the electrolysis system within the target temperatures. According to one exemplary embodiment, when the electrolysis cell stack is operated at a set point temperature of 90° C., it is sufficient to cool the oxygen loaded anolyte withdrawn from the anode section of the electrolysis cell stack to 60° C. After separating the oxygen gas from the cooled loaded anolyte, it may be fully mixed with uncooled catholyte withdrawn from the catholyte gas-liquid separator. The resulting mixed electrolyte has a temperature of 75° C., which is low enough that it can be recycled to the electrolysis cell stack for renewed generation of hydrogen and oxygen.

According to one further embodiment, when the second piping system comprises a mixing device arranged downstream of the anolyte gas-liquid separator and downstream of the catholyte gas-liquid separator, and for the aforementioned reasons, no cooling device is arranged within the second piping system downstream of the mixing device and upstream of the inlet of the electrolysis cell stack.

According to one embodiment, the electrolysis arrangement comprises a third piping system, wherein the third piping system connects an outlet of the cathode section of the electrolysis cell stack and an inlet of the catholyte gas-liquid separator.

According to one further embodiment, and for the aforementioned reasons, no cooling device is arranged within the third piping system.

According to one embodiment, and for the aforementioned reasons, the anolyte cooler arranged downstream of the electrolysis cell stack and upstream of the anolyte gas-liquid separator is the only cooler of the electrolysis arrangement to cool the electrolysis medium. That is, the anolyte cooler arranged downstream of the electrolysis cell stack and upstream of the anolyte gas-liquid separator is the only cooler of the electrolysis arrangement, and no further cooler is present to cool anolyte and/or catholyte and/or mixed electrolyte.

According to one embodiment, the part of the first piping system connecting an outlet of the anolyte cooler with the inlet of the anolyte gas-liquid separator is made of a stainless steel material.

Since the section of the first piping system connecting the outlet of the anolyte cooler and the inlet of the anolyte gas-liquid separator is exposed to the oxygen loaded anolyte at lower temperatures, for instance 60° C., it is possible to produce this part of the first piping system from stainless steel. This is in particular true when the electrolysis arrangement is configured for performing an alkaline electrolysis. According to such an embodiment, the electrolysis medium is an aqueous alkaline medium, in particular an aqueous concentrated potassium hydroxide (KOH) solution with a KOH concentration of up to 30 wt.-%, or up to 35 wt.-%, or up to 40 wt.-%.

According to one embodiment and for the aforementioned reasons, the part of the first piping system connecting an outlet of the anolyte cooler with the inlet of the anolyte gas-liquid separator is not made of a Nickel containing material. In particular, the part of the first piping system connecting an outlet of the anolyte cooler with the inlet of the anolyte gas-liquid separator is not made of a pure Nickel material, in particular a Nickel material containing 99 wt.-% or more Nickel.

According to one embodiment, a housing of the anolyte gas-liquid separator is made of a stainless steel material.

As the oxygen loaded anolyte is supplied to the anolyte gas-liquid separator at lower temperatures due to the downstream arranged anolyte cooler, the housing and optionally further parts of the anolyte gas-liquid separator is also exposed to the oxygen loaded anolyte at lower temperatures, for instance 60° C. or less. Hence, it is possible to produce the housing and optionally further parts of the anolyte gas-liquid separator from stainless steel. This is in particular true when the electrolysis arrangement is configured for performing an alkaline electrolysis. According to such an embodiment, the electrolysis medium is an aqueous alkaline medium, in particular an aqueous concentrated potassium hydroxide (KOH) solution with a KOH concentration of up to 30 wt.-%, or up to 35 wt.-%, or up to 40 wt.-%.

According to one embodiment and for the aforementioned reasons, the housing of the anolyte gas-liquid separator and optionally further parts of the anolyte gas-liquid separator is/are not made of a Nickel containing material. In particular, the housing of the anolyte gas-liquid separator and optionally further parts of the anolyte gas-liquid separator is/are not made of a pure Nickel material, in particular a Nickel material containing 99 wt.-% or more Nickel.

According to one embodiment, the second piping system as a whole is made of a stainless steel material.

The second piping system is exposed to pre-cooled oxygen depleted anolyte withdrawn from the anolyte gas-liquid separator, uncooled hydrogen depleted catholyte withdrawn from the catholyte gas-liquid separator and optionally to a mixture of the aforementioned, in case the second piping system comprises a mixing device. Hence, as the second piping system is not exposed to hot oxygen containing electrolyte, it is due to the inventive electrolysis arrangement possible to produce the second piping system as a whole from a stainless steel material.

According to one further embodiment and for the aforementioned reasons, the second piping system as a whole is not made of a Nickel containing material. In particular, the second piping system as a whole is not made of a pure Nickel material, in particular a Nickel material containing 99 wt.-% or more Nickel.

Furthermore and in general, at least one of the underlying aforementioned problems is at least partially solved by a method for producing hydrogen and oxygen by electrolysis of an electrolysis medium, the method comprising the method steps of
electrochemical splitting of water by means of an electrolysis cell stack, whereby a hydrogen loaded catholyte withdrawn from a cathode section of the electrolysis cell stack and an oxygen loaded anolyte withdrawn from an anode section of the electrolysis cell stack is obtained;
supplying the hydrogen loaded catholyte to a catholyte gas-liquid separator to separate hydrogen from the hydrogen loaded catholyte, whereby hydrogen gas and a hydrogen depleted catholyte is obtained;
supplying the oxygen loaded anolyte to an anolyte gas-liquid separator to separate oxygen from the oxygen loaded anolyte, whereby oxygen gas and an oxygen depleted anolyte is obtained;
withdrawing the hydrogen depleted catholyte from the catholyte gas-liquid separator and recycling the hydrogen depleted catholyte to the cathode section of the electrolysis cell stack;
withdrawing the oxygen depleted anolyte from the anolyte gas-liquid separator and recycling the oxygen depleted anolyte to the anode section of the electrolysis cell stack;
supplying the oxygen loaded anolyte withdrawn from the anode section of the electrolysis cell stack to an anolyte cooler to obtain a cooled oxygen loaded anolyte, before supplying the oxygen loaded anolyte to the anolyte gas-liquid separator.

According to the method of the invention, the oxygen loaded anolyte withdrawn from the anode section of the electrolysis cell stack is supplied to an anolyte cooler to obtain a cooled oxygen loaded anolyte, before said oxygen loaded anolyte is supplied to the anolyte gas liquid separator. That is, the oxygen loaded anolyte is cooled downstream of the electrolysis cell stack, in particular downstream of the anode section of the electrolysis cell stack, and upstream of the anolyte gas-liquid separator. Hence, the oxygen loaded anolyte is supplied as cooled anolyte to the anolyte gas-liquid separator.

According to one embodiment of the method, the electrolysis medium is an aqueous medium, in particular an aqueous alkaline medium, in particular an aqueous concentrated potassium hydroxide (KOH) solution with a KOH concentration of up to 30 wt.-%, or up to 35 wt.-%, or up to 40 wt.-%.

According to one further embodiment of the method, the hydrogen depleted catholyte withdrawn from the catholyte gas-liquid separator and/or the oxygen depleted anolyte withdrawn from the anolyte gas-liquid separator is/are not cooled before it is/they are recycled to the electrolysis cell stack.

Cooling of the oxygen loaded anolyte by means of the anolyte cooler alone is sufficient to keep the temperatures of the electrolysis system within the target temperatures. According to one exemplary embodiment, when the electrolysis cell stack is operated at a set point temperature of 90° C., it is sufficient to cool the oxygen loaded anolyte withdrawn from the anode section of the electrolysis cell stack to 60° C. After separating the oxygen gas from the cooled loaded anolyte, it may be fully mixed with uncooled catholyte withdrawn from the catholyte gas-liquid separator. The resulting mixed electrolyte has a temperature of 75° C., which is low enough that it can be recycled to the electrolysis cell stack to generate hydrogen and oxygen again.

According to one embodiment of the method, the hydrogen depleted catholyte withdrawn from the catholyte gas-liquid separator and the oxygen depleted anolyte withdrawn from the anolyte gas-liquid separator are at least partially mixed to obtain a hydrogen and oxygen depleted mixed electrolysis medium, and the hydrogen and oxygen depleted mixed electrolysis medium is recycled to the electrolysis cell stack. According to this embodiment, the oxygen depleted anolyte and the hydrogen depleted catholyte are supplied to the electrolysis cell stack either separated, partially mixed or fully mixed.

According to one embodiment of the method, when the oxygen depleted anolyte and the hydrogen depleted catholyte are supplied to the electrolysis cell stack either partially mixed or fully mixed, the hydrogen and oxygen depleted mixed electrolysis medium is not cooled before it is recycled to the electrolysis cell stack.

### BRIEF DESCRIPTION OF THE DRAWING

The invention will now be detailed by way of an exemplary embodiment with reference to the attached drawing. Unless otherwise stated, the drawings are not to scale. In the FIGURE and the accompanying description, equivalent elements are each provided with the same reference marks.

For a further understanding of the nature and objects for the present invention, reference should be made to the following detailed description, taken in conjunction with the accompanying drawings, in which like elements are given the same or analogous reference numbers and wherein the figure depicts a simplified flow diagram of an electrolysis arrangement 1 according to one exemplary embodiment of the invention.

### DETAILED DESCRIPTION OF THE PREFERRED EMBODIMENTS

The figure depicts one exemplary embodiment of an electrolysis arrangement 1 according to the invention. It is assumed that the electrolysis arrangement 1 performs an alkaline type electrolysis with 30 wt.-% KOH lye solution as the electrolyte. The electrolysis arrangement 1 comprises an electrolysis cell stack 34, a rectifier 2, an anolyte cooler 11, an anolyte gas-liquid separator 12 with oxygen cooler 14 and a catholyte gas-liquid separator 13 with hydrogen cooler 15 as the main components. The main components are connected via conduits of a first, second and third piping system. The first piping system comprises the conduits 31a and 31b, the second piping system comprises the conduits 32a, 32b and 32c, and the third piping system comprises conduit 33. Furthermore, the electrolysis arrangement comprises a mixing device 21 in order to mix hydrogen depleted catholyte and oxygen depleted anolyte, an electrolyte pump 20 for circulating the electrolysis medium, and a deionised (DI) water supply 19 to compensate for the amount of water consumed by the electrochemical water splitting reaction.

Direct current 3 is supplied to the electrolysis cell stack 34 by means of the rectifier 2. For the sake of simplification, only one electrolysis cell is shown in regards of electrolysis cell stack 34, but the electrolysis cell stack 34 actually contains a plurality of electrolysis cells. The electrolysis cell shown comprises an anode section 6, which consists of an anode 4 and an anode compartment 5. The electrolysis cell further comprises a cathode section 9, which consists of a cathode 7 and a cathode compartment 8. The anode section 6 and the cathode section 9 are separated by a liquid tight membrane 10 which enables the exchange of hydroxyl ions between the anode section 6 and the cathode section 9.

By supplying direct current 3 to the electrolysis cell stack 34, water of the electrolyte lye solution is split into hydrogen (cathode side) and oxygen (anode side). This results in the generation of an oxygen loaded anolyte in the anode section 6 of the electrolysis cell stack 34 and a hydrogen loaded catholyte in the cathode section 9 of the electrolysis cell stack 34.

The oxygen loaded anolyte generated in the anode section 6 is withdrawn from the electrolysis cell stack 34 via an outlet of the anode section 6 (outlet not shown) and supplied via conduit 31a to an inlet of the anolyte cooler 11 (inlet not shown). In the anolyte cooler 11, which is arranged downstream of the electrolysis cell stack 34 and upstream of the anolyte gas-liquid separator 12, the oxygen loaded anolyte is cooled to a sufficiently low temperature by cooling water 26, which is fed to the anolyte cooler 11 in countercurrent to the flow of the oxygen loaded anolyte. The heated cooling water 27 is withdrawn from the anolyte cooler 11 and is re-cooled by e.g. an air cooler (not shown).

The cooled oxygen loaded anolyte is withdrawn via an outlet of the anolyte cooler 11 (outlet not shown) and supplied via conduit 31b to an inlet of the anolyte gas-liquid separator 12 (inlet not shown). In anolyte gas-liquid separator 12, oxygen gas is separated from the oxygen-loaded anolyte, whereby an oxygen depleted anolyte and oxygen gas is obtained. The oxygen gas still contains uncondensed water. Hence, it is cooled in oxygen cooler 14 by indirect cooling. Therefore, oxygen cooler 14 is supplied with cooling water 24. The thereby condensed water is returned to the anolyte gas-liquid separator 12. Heated cooling water 25 is withdrawn from oxygen cooler 14 and re-cooled by e.g. an air cooler (not shown). Dry oxygen gas 17 is withdrawn from oxygen cooler 14 and fed to a further processing step.

As water is continuously consumed by the water electrolysis process, the electrolysis arrangement 1 comprises a DI water storage tank to compensate for the consumed water and balance the amount of water which is in the process. According to the embodiment of the figure, DI water 19 is supplied from the DI water storage tank 18 to the anolyte gas-liquid separator 12 to be introduced into the electrolysis system.

The hydrogen loaded catholyte generated in the cathode section 9 is withdrawn from the electrolysis cell stack 34 via an outlet of the cathode section 9 (outlet not shown) and supplied via conduit 33 to an inlet of the catholyte gas-liquid separator 13 (inlet not shown). No further cooling device is arranged within conduit 33. In catholyte gas-liquid separator 13, hydrogen gas is separated from the hydrogen loaded catholyte, whereby a hydrogen-depleted catholyte and hydrogen gas is obtained. The hydrogen gas still contains uncondensed water. Hence, it is cooled in hydrogen cooler 15 by indirect cooling. Therefore, hydrogen cooler 15 is supplied with cooling water 22. The thereby condensed water is returned to the catholyte gas-liquid separator 13. Heated cooling water 23 is withdrawn from hydrogen cooler 15 and re-cooled by e.g. an air cooler (not shown). Dry hydrogen gas 16 is withdrawn from hydrogen cooler 15 and fed to a further processing step.

Oxygen depleted anolyte is withdrawn from the anolyte gas-liquid separator 12 and supplied via conduit 32a to the mixing device 32b. Hydrogen depleted catholyte is withdrawn from the catholyte gas-liquid separator 13 and supplied via conduit 32b to mixing device 21. In mixing device 21, oxygen depleted anolyte and hydrogen depleted catholyte are fully mixed, whereby a mixed hydrogen and oxygen depleted electrolyte is obtained. The mixed oxygen and hydrogen depleted electrolyte is recycled via conduit 32c to the electrolysis cell stack 34, whereby it is routed to an anode inlet and a cathode inlet after splitting the volume flows in a ratio of one to one. In the electrolysis cell stack 34, the oxygen and hydrogen depleted electrolyte is processed for the renewed splitting of water by the electrolysis reaction. Conduits 32a, 32b and 32c form the second piping system. No further cooling device is arranged within this second piping system.

According to the alkaline electrolysis arrangement 1 of the figure, the electrolysis cell stack 34 is operated at a set temperature of 90° C. That is the hydrogen loaded catholyte and the oxygen loaded anolyte are withdrawn from the electrolysis cell stack having a temperature of approximately 90° C. By the anolyte cooler 11, the oxygen loaded anolyte is cooled down to a temperature of 60° C. That is, the oxygen loaded anolyte in conduit 31b and the oxygen depleted anolyte of conduit 32a have a temperature of approximately 60° C. The hydrogen loaded catholyte in conduit 33 and the hydrogen depleted catholyte in conduit 32b have a temperature of approximately 90° C., as no further cooling device is arranged within the second piping system. In the mixing device 21, hydrogen depleted catholyte having a temperature of approximately 90° C. and oxygen depleted anolyte having a temperature of approximately 60° C. are mixed, which results in a mixed hydrogen and oxygen depleted electrolyte temperature of approximately 75° C. Hence, the mixed electrolyte is recycled to the electrolysis cell stack 34 having a temperature of approximately 75° C. In the electrolysis cell stack 34, said mixed electrolyte is again heated to 90° C. as a consequence of the electrolysis reaction within the stack.

The aforementioned scenario is further discussed in detail in the following.

Operating conditions of the alkaline electrolysis arrangement are:
30 wt.-% aqueous KOH lye solution as the electrolysis medium;
The outlet streams of the electrolysis cell stack 34 (conduits 31a and 33) are at 90° C.;
The allowable temperature difference from inlet to outlet of the electrolysis cell stack 34 is 15° C.;
The inlet mixed electrolyte stream into the electrolysis cell stack 34 is split 1:1 between the anode section 6 and cathode section 9 (not shown in the figure).

By arranging the electrolyte cooler downstream of the anode section 6 of the cell stack 34, it is possible to reduce the temperature of the stream by twice the amount of temperature increase in the cell stack 34 (dT_{stack}). This is not possible when the electrolyte cooler is arranged in conduit 32c since, if one would cool by more than the dT_{stack}, one would reduce the operating temperature of the electrolysis arrangement, making it less efficient. The present invention enables to reach these lower temperatures because an electrolyte stream is cooled (i.e. the anolyte stream) which is 50% of the total electrolyte inlet stream into the cell stack 34. This is shown in the energy balance below.
Allowable temperature increase in the cell stack for the scenario if the figure is dTstack = 15° C.
Total electrolyte flow (anode + cathode side) to maintain temperature increase in cell stack = Vₜₒₜₐₗ
Electrolyte flow into anode and cathode section (50/50 split), Vanode = Vₜₒₜₐₗ / 2 = V_{cathode}
To maintain a steady operating temperature of the electrolysis arrangement, the heat generated in the cell stack (Q_{stack}) has to equal the heat removed from the system (Q_{cooling}): Q_{stack} = Q_{cooling}
Q_{stack} and Q_{cooling} equal to a temperature change of the electrolyte in the stack and in the cooler (heat exchanger - HX) respectively: Vₜₒₜₐₗ * rho_{KOH} * cp_{KOH} * dT_{stack} = V_{anode} * rho_{KOH} * CpKOH * dTHX, wherein rho_{KOH} is the density of the electrolysis medium and cp_{KOH} is the heat capacity of the electrolysis medium
This can be simplified, since rho_{KOH} and cp_{KOH} can be regarded as being constant with these small temperature differences: Vₜₒₜₐₗ * dT_{stack} = (Vₜₒₜₐₗ / 2) * dT_{HX} → dT_{HX} = 2 * dT_{stack}
For our scenario, this leads to: dT_{HX} = 30° C. → Tₒᵤₜₗₑₜ from _{HX} = 60° C.
Since the hydrogen stream is not cooled, it remains at 90° C., and since it has the same flowrate as the oxygen stream after their mixing upstream the pump, it results: T _{after} _{mixing} = 75° C. = Tᵢₙₗₑₜ ₜₒ _{stack}

Reducing the temperature of the oxygen loaded anolyte to 60° C. instead of 90° C., when the electrolyte cooler would be arranged in conduit 32c, less corrosion resistant materials can be used to still ensure low corrosion rates. For instance, stainless steel can be chosen as a material for conduit 31b, for the housing of anolyte gas-liquid separator 12 and for conduit 32a. In case the electrolyte cooler would be arranged within conduit 32c upstream of the electrolysis cell stack 34, a pure Nickel material would have to be used for the oxygen loaded anolyte carrying conduits and housings. Because in the case, those conduits and housings would be exposed to a temperature of 90° C.

The solubility of the oxygen gas does not change significantly with temperatures within the aforementioned temperature range (60° C. to 90° C.). For instance, in case of 30 wt.-% KOH at 30 bar, the solubility of oxygen at 90° C. is 56.5 wt.-ppm and for 60° C. it is 56.1 wt.-ppm according to the solubility model and data of Shoor et al., published in 1968 as “Salting out of nonpolar gases in aqueous potassium hydroxide solution”.

The anolyte cooler 11 has to handle a two-phase flow (anolyte and gaseous oxygen) and therefore preferably has a straight vertical arrangement preventing any possible dead-spots where oxygen gas can be trapped. The tubing or plating, depending on the heat exchanger type chosen, is made out of corrosion resistant material as it is subject to an anolyte-oxygen mixture under a high temperature. However, these components are easier to manufacture and are available in standardized pieces, making them relatively cheaper than an entire gas-liquid separator made out of the respective corrosion resistant material.

To maintain a 50/50 split at the inlet to the electrolysis cell stack 34, a pressure resistive element can be placed on the cathode section outlet to balance the pressure drop introduced by placing the electrolysis cell stack on the anode outlet stream.

### List of Reference Signs

1 electrolysis arrangement

2 rectifier

3 direct current

4 anode

5 anode compartment

6 anode section

7 cathode

8 cathode compartment

9 cathode section

10 membrane

11 anolyte cooler

12 anolyte gas-liquid separator

13 catholyte gas-liquid separator

14 oxygen cooler

15 hydrogen cooler

16 hydrogen gas

17 oxygen gas

18 DI water storage tank

19 DI water supply

20 electrolyte pump

21 mixing device

22 cooling water hydrogen cooler (in)

23 cooling water hydrogen cooler (out)

24 cooling water oxygen cooler (in)

25 cooling water oxygen cooler (out)

26 cooling water anolyte cooler (in)

27 cooling water anolyte cooler (out)

31a, 31b conduits of first piping system

32a, 32b, 32c conduits of second piping system

33 conduit of third piping system

34 electrolysis cell stack

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. An electrolysis arrangement, comprising:
an electrolysis cell stack comprising a plurality of electrolysis cells for the electrochemical generation of hydrogen and oxygen from an electrolysis medium, wherein the electrolysis cell stack comprises an anode section for the generation of oxygen and a cathode section for the generation of hydrogen;
an anolyte gas-liquid separator for the separation of oxygen gas from an oxygen loaded anolyte portion of the electrolysis medium;
a catholyte gas-liquid separator for the separation of hydrogen gas from a hydrogen loaded catholyte portion of the electrolysis medium;
an anolyte cooler, wherein said anolyte cooler is arranged downstream of the electrolysis cell stack and upstream of the anolyte gas-liquid separator, in order to cool the oxygen loaded anolyte portion of the electrolysis medium before entering the anolyte gas-liquid separator.

2. The electrolysis arrangement according to claim 1, wherein the electrolysis medium is an aqueous concentrated potassium hydroxide solution with a potassium hydroxide concentration of up to 30 wt.-%.

3. The electrolysis arrangement according to claim 1, wherein the anolyte cooler is arranged within a first piping system, wherein the first piping system connects an outlet of the anode section of the electrolysis cell stack and an inlet of the anolyte gas-liquid separator.

4. The electrolysis arrangement according to claim 1, wherein the electrolysis arrangement comprises a second piping system, wherein the second piping system connects an outlet of the anolyte gas-liquid separator and an outlet of the catholyte gas-liquid separator with an inlet of the electrolysis cell stack, configured to withdraw hydrogen depleted catholyte from the catholyte gas-liquid separator and to withdraw oxygen depleted anolyte from the anolyte gas-liquid separator, and to supply the hydrogen depleted catholyte and the oxygen depleted anolyte to the electrolysis cell stack.

5. The electrolysis arrangement according to claim 4, wherein the second piping system comprises a mixing device arranged downstream of the anolyte gas-liquid separator and downstream of the catholyte gas-liquid separator, configured to at least partially mix the hydrogen depleted catholyte and the oxygen depleted anolyte to obtain a mixed hydrogen and oxygen depleted electrolyte, to supply the mixed hydrogen and oxygen depleted electrolyte to the inlet of the electrolysis cell stack.

6. The electrolysis arrangement according to claim 4, wherein no cooling device is arranged within the second piping system.

7. The electrolysis arrangement according to claim 5, wherein no cooling device is arranged within the second piping system downstream of the mixing device and upstream of the inlet of the electrolysis cell stack.

8. The electrolysis arrangement according to claim 1, wherein the electrolysis arrangement comprises a third piping system, wherein the third piping system connects an outlet of the cathode section of the electrolysis cell stack and an inlet of the catholyte gas-liquid separator.

9. The electrolysis arrangement according to claim 3, wherein the part of the first piping system connecting an outlet of the anolyte cooler with the inlet of the anolyte gas-liquid separator is made of a stainless steel material.

10. The electrolysis arrangement according to claim 1, wherein a housing of the anolyte gas-liquid separator is made of a stainless steel material.

11. The electrolysis arrangement according to claim 4, wherein the second piping system as a whole is made of a stainless steel material.

12. The electrolysis arrangement according to claim 1, wherein the anolyte cooler is arranged directly at or proximately to the outlet of the anode section of the electrolysis cell stack.

13. A method for producing hydrogen and oxygen by electrolysis of an electrolysis medium, the method comprising:
electrochemical splitting of water by means of an electrolysis cell stack, whereby a hydrogen loaded catholyte withdrawn from a cathode section of the electrolysis cell stack and an oxygen loaded anolyte withdrawn from an anode section of the electrolysis cell stack is obtained;
supplying the hydrogen loaded catholyte to a catholyte gas-liquid separator to separate hydrogen from the hydrogen loaded catholyte, whereby hydrogen gas and a hydrogen depleted catholyte is obtained;
supplying the oxygen loaded anolyte to an anolyte gas-liquid separator to separate oxygen from the oxygen loaded anolyte, whereby oxygen gas and an oxygen depleted anolyte is obtained;
withdrawing the hydrogen depleted catholyte from the catholyte gas-liquid separator and recycling the hydrogen depleted catholyte to the cathode section of the electrolysis cell stack;
withdrawing the oxygen depleted anolyte from the anolyte gas-liquid separator and recycling the oxygen depleted anolyte to the anode section of the electrolysis cell stack;
supplying the oxygen loaded anolyte withdrawn from the anode section of the electrolysis cell stack to an anolyte cooler to obtain a cooled oxygen loaded anolyte, before supplying the oxygen loaded anolyte to the anolyte gas-liquid separator.

14. The method according to claim 13, wherein the electrolysis medium is an aqueous concentrated potassium hydroxide solution with a potassium hydroxide concentration of up to 30 wt.-%.

15. The method according to claim 13, wherein the hydrogen depleted catholyte withdrawn from the catholyte gas-liquid separator and/or the oxygen depleted anolyte withdrawn from the anolyte gas-liquid separator is/are not cooled before being recycled to the electrolysis cell stack.

16. The method according to claim 13, wherein the hydrogen depleted catholyte withdrawn from the catholyte gas-liquid separator and the oxygen depleted anolyte withdrawn from the anolyte gas-liquid separator are at least partially mixed to obtain a hydrogen and oxygen depleted mixed electrolysis medium, and the hydrogen and oxygen depleted mixed electrolysis medium is recycled to the electrolysis cell stack.

17. The method according to claim 16, wherein the hydrogen and oxygen depleted mixed electrolysis medium is not cooled before being recycled to the electrolysis cell stack.
